(19) United States
(12) Patent Application Publication
(10) Pub. No.: US 2014/0304445 A1
(43) Pub. Date: Oct. 9, 2014

(54) MEMORY BUS LOADING AND CONDITIONING MODULE

(71) Applicant: William Michael Gervasi, Ladera Ranch, CA (US)

(72) Inventor: William Michael Gervasi, Ladera Ranch, CA (US)

(21) Appl. No.: 13/859,613

(22) Filed: Apr. 9, 2013

(51) Int. Cl. G06F 13/40

(52) U.S. Cl. CPC G06F 13/4068
USPC 710/301

(57) ABSTRACT

A bus load module plugs into otherwise empty memory sockets on a memory bus. The bus load module conditions signals on the memory bus to improve signal quality and timing of the modules on the bus populated with memory, thereby improving system performance. The bus load module options include EEPROMs to interface to the system host to report load module configuration and capabilities.

### FIELD OF THE INVENTION

The invention concerns electrical improvements for communication buses between memory controllers and memory subsystems with multiple sockets.

### BACKGROUND OF THE INVENTION

Computer memory subsystems typically have a central memory controller coupled with multiple sockets, each of which can optionally be populated with a module containing one or more ranks of memory devices on its data bus. Only one memory module with at least one rank of memory installed is required for the memory channel to function. Typical memory buses today have one, two, or three sockets. Typical memory modules today contain one, two, or four ranks of memory.

The memory controller is typically wired in a daisy chain configuration with a first socket nearer the memory controller, a second socket further away, and the third socket even further from the memory controller. The position of each socket on the daisy chain affects how it will impact the quality of signals on the bus, and in particular, how fluctuations from effects such as reflections will affect the functioning of the bus.

The optionality of populated and empty sockets, coupled with options to populate each module with one or more ranks of memory, creates a large array of possible configurations. This matrix of loading combinations creates a variety of fluctuations on the electrical signals on the bus, and every combination must be simulated and tested in order to design a high quality memory subsystem. For example, a system with three slots in which any slot may have 0, 1, 2, or 4 ranks of memory has 63 possible combinations to evaluate on its data bus.

| Combination | Socket 0 | Socket 1 | Socket 2 |
|---|---|---|---|
| 1 | Empty | Empty | One rank |
| 2 | Empty | One rank | Empty |
| 3 | Empty | One rank | One rank |
| 4 | One rank | Empty | Empty |

| | |
|---|---|
| • • • | • • • |

| | | | |
|---|---|---|---|
| 62 | Four ranks | Four ranks | Two ranks |
| 63 | Four ranks | Four ranks | Four ranks |

The fluctuations on the bus are largely a function of the loading each socketed module presents to the bus, with capacitance being a key aspect of that loading. A four rank module presents approximately four times as much capacitance as a one load module, for example, due to the additional memory devices connected to the bus. Each of the rank populations will therefore inject a unique set of fluctuations onto the bus.

Since the position of the socket relative to the memory controller affects the bus signal quality differently, total loading is not the only factor. Specifically, a configuration such as “empty—one rank—four ranks” is not electrically equivalent to “four ranks—empty—one rank” even though the total capacitance is the same. The fluctuations injected onto the bus are unique for each combination of loadings in each slot.

The data bus on typical memory modules also includes a series damping resistor between the card edge contact (finger) and the memory devices. These series damping resistors reduce the fluctuations on the data bus by partially isolating the loading effects of the memory ranks

Current generation memory devices typically incorporate an on-die termination (ODT) circuit on data bus signals that allows the perturbations on the data bus to be reduced.

Memory subsystems also have address bus signals which have a wider variety of configurations than the data buses. For registered modules, the address bus signals may be coupled to one or two registering clock driver chips on each module, one or both of which may internally provide a resistive termination to a termination voltage VTT with input bus termination (IBT), a function similar to the memory device ODT used on data buses.

For unbuffered modules, the address bus signals may be coupled to 4, 5, 8, 9, 10, 16, or 18 memory devices directly. Unbuffered modules typically terminate resistively to a termination voltage, VTT, at the end of a daisy chain of memory devices. Empty sockets are particularly problematic for unbuffered systems where the lack of termination on the empty socket complicates signal integrity for the memory controller which must design for very different termination environments.

Associated with address bus signals are command signals (examples are RAS#, CAS#, and WE#) , control signals (examples are CS#, CKE and ODT), and clock signals (examples are CK and CK#). While command, control, and clock signals are often routed similarly to address signals, they may have different loading based on the module configuration. For example, a module with two ranks of memory devices may place 18 loads on address, 18 loads on command, 9 loads on control, and 9 loads on clock signals. This creates an imbalance in signal loading that must be considered when designing a memory subsystem.

Termination is a critical part of current system design. Termination schemes reduce the perturbations on data and address signals and their related mask, strobe, command, control and clock signals as well. The reduction in line perturbation is critical to increases the frequency of operation and the reliability of data transferred on those lines. All of the methods described here help reduce perturbations, but cannot eliminate them.

Standard memory modules also contain a serial presence detect (SPD) EEPROM on each module that describes the module's characteristics to the memory controller host processor. Information such as the number of ranks and the module type (e.g., unbuffered or registered) are encoded on the SPD. The number of registering clock driver chips installed on registered modules is also described. The supported frequency range of operation is coded on the SPD. The SPD is coupled to sideband signals (I²C or SMBus) and does not affect the main system bus loading.

### SUMMARY OF THE INVENTION

A bus loading module simulates, from a loading perspective, the presence of one or more ranks of memory. Inserting bus loading modules into an otherwise empty socket reduces the number of combinations of bus loadings that would otherwise need to be evaluated. For bus signals, the loading may be a series damping resistor, a capacitive load, a termination resistance to a termination voltage VTT, or a combination of any of these. Each signal type such as data, strobe, mask, address, command, control, or clock may require a unique combination of damping, termination, and loading as well as different values for resistance or capacitance. Though less commonly used, inductance may also be used to complete such filters on line perturbations.

Indirectly, the bus loading module simplifies system design and improves the overall quality of the bus by reducing the number of possible combinations of fluctuations.

These bus loading modules are optional. The bus can function without these load modules installed. However, the signal quality improvements when these load modules installed advantageously reduces the bit error rate on the bus and allows higher operating frequency when installed.

The presence of these modules can be detected by having the memory controller execute signal quality tests, or by incorporating a serial presence detect (SPD) EEPROM on each load module to identify its characteristics to the system.

These bus loading modules may be constructed to exactly simulate one of the common loading characteristics such as a one rank module, a two rank module, or a four rank module. Using a simple example of a load module simulating two loads, for example, the matrix of evaluation configurations for a three socket system may be reduced from 63 combinations to 26 combinations, a reduction of more than 58% in complexity by eliminating the combinations with “empty” sockets.

| Combination | Socket 0 | Socket 1 | Socket 2 |
|---|---|---|---|
| 1 | One rank | One rank | One rank |
| 2 | One rank | One rank | Two ranks |
| 3 | One rank | Two ranks | One rank |
| 4 | Two ranks | One rank | One rank |

| | |
|---|---|
| • • • | • • • |

| | | | |
|---|---|---|---|
| 25 | Four ranks | Four ranks | Two ranks |
| 26 | Four ranks | Four ranks | Four ranks |

To those skilled in the art, it is clear that the loading can be adjusted based on simulation and testing to provide other advantageous configurations such as 1.5 loads or 3 loads yet provide the benefits of simplification.

Different systems may get better optimization from different load module types. Unique bus load modules may be used for unbuffered memory subsystems, registered memory subsystems, or other configurations, based on typical system loading configurations.

### BRIEF DESCRIPTION OF THE DRAWINGS

FIG. 1 shows a typical computer system motherboard with a memory controller 100 (often incorporated into the CPU) attached to a motherboard 101. The memory controller connects through relatively longer electrically conductive traces 102 to memory module option sockets 103, 104, 105 in turn in a daisy chain of relatively shorter traces. Each socket may be empty or populated with memory modules 106, 107, 108, one per socket.

FIG. 2 shows stylized block diagrams of a one rank memory module 200, a two rank memory module 201, and four rank memory module 202. A rank of memory is defined as a collection of memory chips sharing a rank select signal but having unique data signals, such as the eight devices shown in each rank 208, 209, 210, 211. In actual modules, these ranks of memory may be on front and back sides of a module or incorporated into multi-chip stacks. Data signals enter the module via a card edge pad called a finger 203 which makes electrical contact with the socket once installed. The data signals connect from the finger through trace 204 through a series damping resistor 205 to connect 206 to the data signals on the memory chips 207. Each data signal at the finger connects through a resistor to one memory chip on a one rank module, two memory chips on a two rank, and four memory chips on a four rank module. The simplified diagrams show 8 data signals; typical modules have 64 or 72 data bits, and also strobe and mask signals that are identically loaded to a data bit.

FIG. 3 shows a simplified electrical model of the loading on a data bus for an empty socket (no load), one rank, two ranks, and four ranks Expressed as a capacitor, each rank presents one load on the data bus. A one rank module has a single load 301, a two rank module increases by a second load 302, and four rank module by another two more loads 303. With typical loads of approximately 2pF per data pin per memory chip, this translates to 0pF, 2pF, 4pF, and 8pF for the empty socket, one, two, and four rank modules respectively.

FIG. 4 shows data bus loading for a simplified implementation of one variation of bus loading module, this example for a module simulating the bus load of a two rank memory module. The module form factor is similar to a memory module with similar module width and size and placement of all contact fingers. The data signal from the finger on the load module is routed through a resistor 401 to one or more capacitors 402 which places a load on the data bus electrically similar to two memory chip loads, such as 4pF of capacitance. It is obvious to those skilled in the art that the value of the capacitance 402 can easily be adjusted to simulate one, two, or four ranks, or to any advantageous capacitive load that is shown to improve signal quality on the bus for a given configuration. The series damping resistor 401 may be optional based on simulation and testing as well; for illustration purposes it is included in the simplified diagrams.

FIG. 5 shows the “flyby” routing of a typical address signal on an unbuffered memory module from its entry point onto the module though finger 506, routed through a trace 501 past all memory chips 502 on the bus. The trace 501 connects via a shorter stub trace 507 to each memory chip as it passes, and connects to a termination resistor 504. The other terminal of resistor 504 is to a trace that connects to a termination voltage finger VTT 505 or other on-board termination voltage.

FIG. 6 shows a simplification of an electrical model of FIG. 5 where each memory device on the flyby signal route 601 appears to the host memory controller as a capacitive load 602. Since these capacitors appear in parallel, they may be lumped as a capacitive load of value “n times Ci” where n is the number of memory devices connected to the flyby bus signal and Ci is the capacitance of one memory device input pin. For example, if Ci=1 pF for each device and there are eight memory devices, the total load is 8 pF. This is also a model for one variation of a bus loading module which loads each address signal with a capacitive load which may be several distributed capacitors or a single capacitor representing the desired number of loads, and a termination resistor to the termination voltage VTT. Those skilled in the art will recognize that the load capacitors may also be connected to other voltages, such as the module power supply voltage, rather than ground.

FIG. 7 shows an optional feature of a bus loading module that complements the feature set. All standard modules contain a serial presence detect (SPD) chip which contains information regarding the module capabilities, therefore adding an SPD 701 to a bus loading module requires minimal change to the system infrastructure. These devices typically communicate to the host system over a serial bus, I2C 702 which are sideband signals on separate fingers 703 which are completely isolated from the memory bus and bus loading circuits 700. The SPD contains at least some EEPROM non-volatile memory cells and optionally a thermal sensor as well, all of which may be interrogated over the I2C bus. The EEPROM portion of the SPD can be used to store information regarding the configuration of the bus loading module such as its presence, the number of loads it represents electrically to the bus, the type of termination scheme used for each signal type, the module physical dimensions, and other relevant information. The thermal sensor part of the SPD, if present, may be used to monitor system temperature or other optional devices installed on the load module, and read over the same I2C bus as the EEPROM contents.

FIG. 8 shows simplified diagram of a bus loading module that simulates on-die termination of the memory data signals, typical of most memory modules, and also on-die termination of address signals, typical of registered or load reduced memory modules.

FIG. 9 shows a simplified diagram of a registered memory module where all address signals are connected from the fingers 901 through a series damping resistor 902 to a registering clock driver (RCD) 903. The RCD retransmits the address signals through traces 904 to memory chips 905 on both sides of the RCD, terminating through resistors 9-6 to the termination voltage VTT pins 907. On each flyby address bus output from the RCD, memory devices connect to the bus 908, but these connections are not visible to the system bus having been isolated by the RCD.

FIG. 10 shows a simplified electrical model of a load module for a registered memory module. Each data signal is loaded with the equivalent capacitance 1001 as one or more ranks of memory. Each address signal is loaded with the equivalent capacitance of an RCD input 1002. For load modules simulating registered memory modules containing two RCDs, this loading can easily be doubled to represent both RCDs.

FIG. 11 shows various implementations of line termination in preferred embodiments of the invention.

FIG. 12 shows an implementation of a bus loading module design complete with loading circuits for data and address signals, plus a serial presence detect (SPD) device on the I2C bus.

FIG. 13 shows a simplified diagram of the address 1306, command 1305, control 1303, 1304 and clock 1301, 1302 signals for a typical two rank unbuffered memory module with nine DRAMs per rank. Each address and command signal is common and connects to all 18 DRAMs whereas each clock and control signals are distinct per rank and each connects to 9 DRAMs. Clock A 1301 and Control A 1303 are connected to one rank of memory 1307 and Clock B 1302 and Control B 1304 are connected to another rank of memory 1308.

FIG. 14 shows a simplified diagram of the signal loading as seen by the memory controller for the module in FIG. 13. Loading on address 1406 and command 1405 signals are 18 capacitive loads 1408 representing one DRAM input load each whereas loading on control 1403, 1404 and clock 1401, 1402 signals is half that with 9 capacitive loads 1407 each.

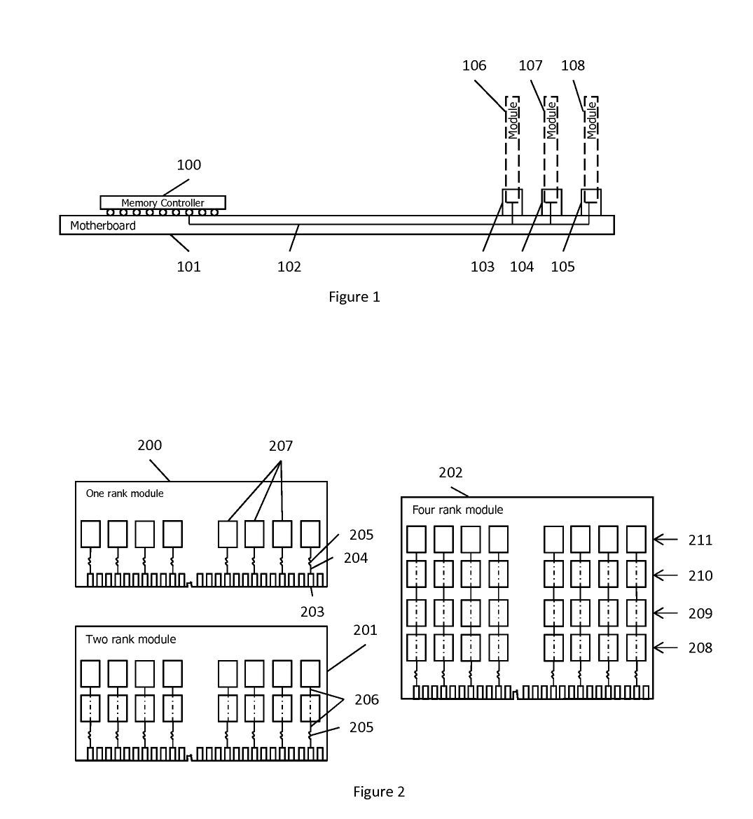

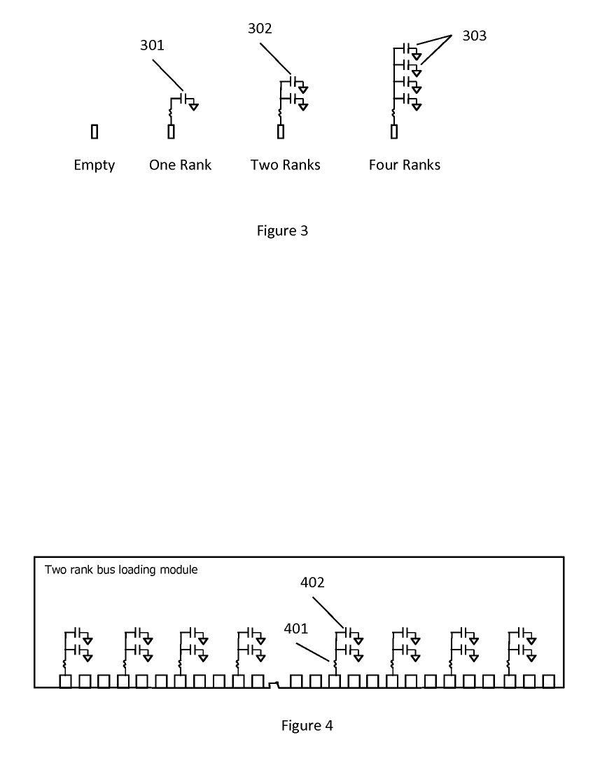

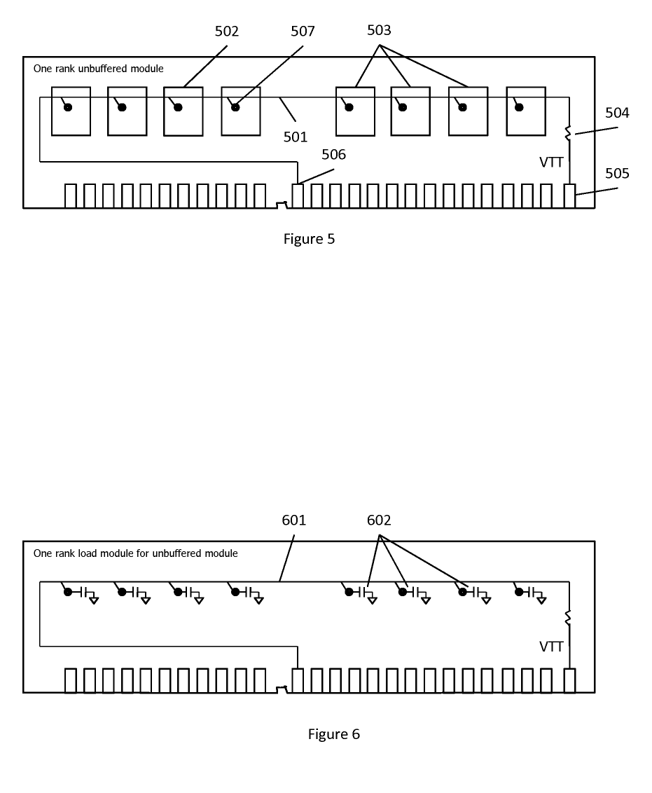

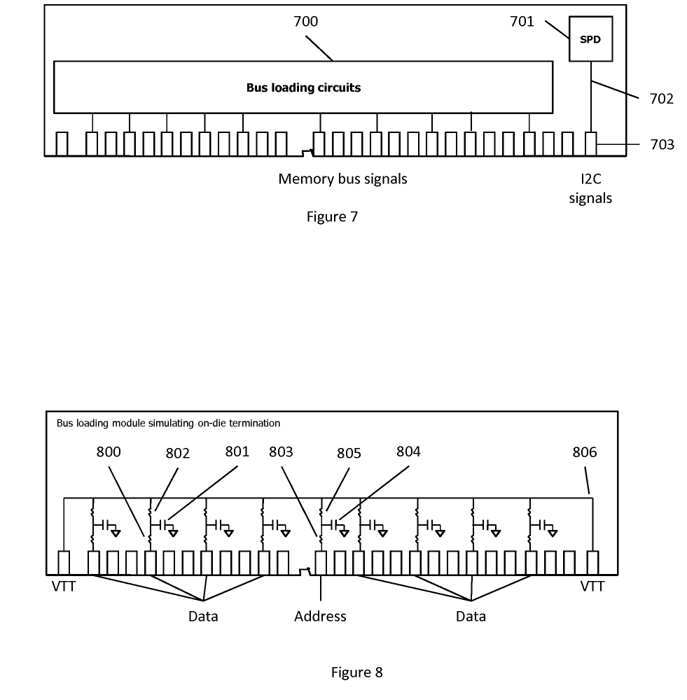

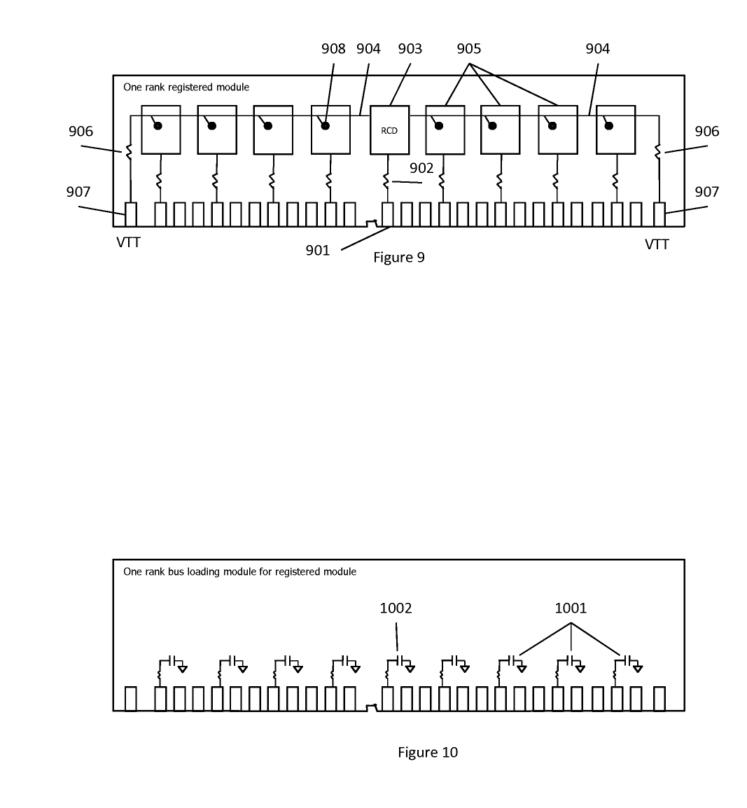

### DESCRIPTION OF PREFERRED EMBODIMENTS OF THE INVENTION

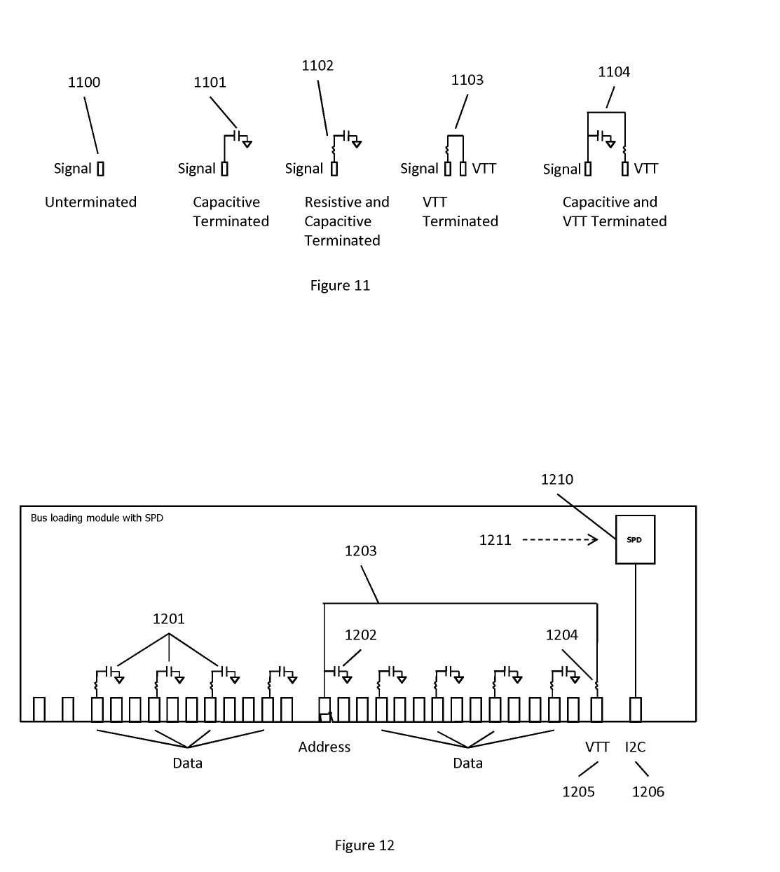

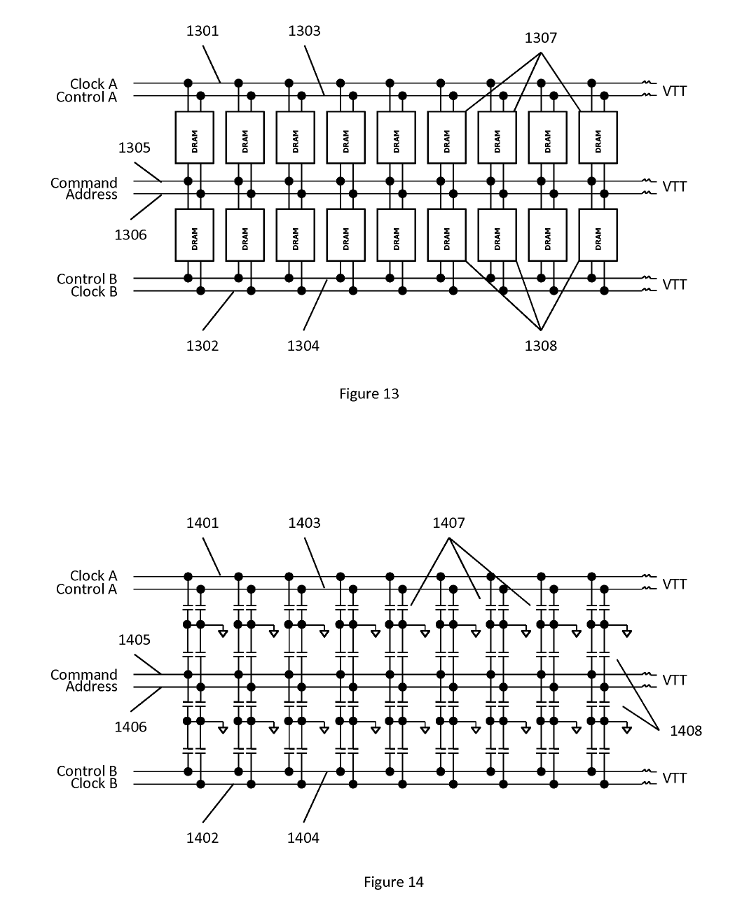

FIG. 11 shows various implementations of line termination in preferred embodiments of the invention. 1100 shows an unterminated signal at the edge connector finger, the standard solution without a bus load module (empty socket). 1101 shows a signal terminated with only a capacitive load. 1102 shows a resistor and capacitor used to load and terminate a signal. 1103 shows a signal resistively terminated to the termination voltage VTT. 1104 shows a signal capacitively loaded and terminated to VTT.

Bus load modules are constructed of typical printed circuit board materials, have a standard outline and pinout for plug-in connectivity in standard memory sockets of the systems in which they are targeted to operate. In its simplest form, a bus loading module wires from the edge connector fingers to capacitive loads on signals using standard surface mount capacitors or embedded capacitive substrates. Each capacitor may have a different value based on the type of signal it is connected to, such as a data bit, strobe, mask, address, command, control, or clock. The values of the capacitances may be chosen to simulate the loading characteristics of one or more ranks of memory, or to represent a different load that improves overall signal quality on the bus.

To reduce ringing on the bus signals from purely capacitive loads, resistors between the edge connector contacts and the load capacitors may be employed to advantageously provide a filtering to complement the signals on the bus to reduce perturbations and reduce signal noise.

Resistive elements to a termination voltage such as VTT may also be incorporated on bus loading modules to reduce reflections on the bus. These may be in addition to capacitive loads for load matching or standalone to simply reduce perturbations on the bus signals.

A serial presence detect (SPD) device may be incorporated onto a bus loading module in order to allow the system to interrogate its capabilities. The EEPROM contents can store information regarding the module type (e.g., unbuffered or registered), the memory generation represented (e.g., DDR4 SDRAM), and the number of rank loads represented on the data signals (e.g., 1, 2, or 4 or another value).

FIG. 12 shows a composite implementation of one common configuration of bus loading modules with all data signals damped by a series resistor and loaded by a capacitor 1201. All address, control, and clock signals are loaded with a capacitor 1202 and resistively 1204 tied to VTT 1205. The SPD is tied to I2C bus signals 1206 on the module edge connector fingers. Thermal information 1211 may be directed to thermal sensors on the SPD to be read by the system over the I2C bus 1206.

FIG. 8 shows an embodiment of a bus loading module that simulates on-die termination of the memory data signals, typical of most memory modules, and also on-die termination of address signals, typical of registered or load reduced memory modules. In this embodiment, a data signal from the finger has a series damping resistor 800, a loading capacitor 801, and a resistor termination 802 to VTT 806. An address signal from its finger passes through a series damping resistor 803 to a loading capacitor 804 and a termination resistor 805 to VTT 806. The values of the resistors and capacitors may be the same or different based on the signal type and the results of simulation and testing.

FIG. 14 shows an embodiment of a bus loading module that simulates loading on address, command, control, and clock signals for a typical two rank unbuffered memory module with nine DRAMs per rank. These capacitive loads may be distributed as shown or lumped together using a reduced number of capacitors with similar total capacitance.

Related Patents

| | | |
|---|---|---|
| 6,539,449 | Leddige | Capacitively loaded continuity module |
| 6,636,943 | Stancil | Method for detecting continuity modules |
| | | in a Direct Rambus subsystem |
| 6,356,106 | Greeff | Active termination in a multidrop memory system |

What is claimed is:

1. A computer memory bus load module system, comprising A printed circuit board (PCB) with contact fingers compatible with interfacing to a standard memory module socket for the purpose of inserting into said socket;
Active or passive electronic components “loads” on the PCB wired to the appropriate contact fingers on the circuit board to affect electrical signals such as data, address, and other signals;
Loads chosen to simulate the loading characteristics of memory or other advantageous loading characteristics;
Loads chosen to simulate the loading characteristics of support interface devices or other advantageous characteristics;

2. An optional serial presence detect (SPD) device on the bus load module of claim 1 comprising Electrical connection to the fingers representing the system SPD bus such as I2C bus;
Information stored in the SPD EPROM regarding the configuration and capabilities of the bus load module;
Optional thermal sensing to report the temperature of the module, its devices, or surrounding air;
